(19) United States
(12) Patent Application Publication
(10) Pub. No.: US 2022/0266283 A1
(43) Pub. Date: Aug. 25, 2022

(54) SPRAY GUN NOZZLE

(71) Applicant: TIANJIN UNIVERSITY, Tianjin (CN)

(72) Inventors: Junjie Liu, Tianjin (CN); Qianwen Wang, Tianjin (CN)

(21) Appl. No.: 17/632,456

(22) PCT Filed: Nov. 9, 2020
(86) PCT No.: PCT/CN2020/127487

§ 371 Date: Feb. 2, 2022

(30) Foreign Application Priority Data
Feb. 28, 2020 (CN) 202020226586.4

(51) Int. Cl. B05B 12/18; B05B 7/06

(52) U.S. Cl. CPC B05B 12/18; B05B 7/064

(57) ABSTRACT

A spray gun nozzle is provided, including: a hood located outside a central nozzle and connected to a spray gun; an annular snout sleeved on the hood and connected to the hood, wherein the annular spout includes: a first pipe body; a second pipe body sleeved with the first pipe body; an annular bottom surface connected with an end of the first pipe body and an end of the second pipe body, wherein the first pipe body, the second pipe body and the annular bottom surface form an annular cavity; and an annular spout air inlet provided on the annular bottom surface and communicated with the annular cavity; and an annular spout air inlet pipe connected with the annular spout air inlet.

This application is a U.S. National Stage Filing under 35 U.S.C. § 371 from International Application No. PCPCN2020/127487, filed on Nov. 9, 2020, and published as WO2021/169398 on Sep. 2, 2021, which claims the benefit of priority to Chinese Application No. 202020226586.4, filed on Feb. 28, 2020; the benefit of priority of each of which is hereby claimed herein, and which applications and publication are hereby incorporated herein by reference in their entireties.

### TECHNICAL FIELD

The present disclosure relates to a field of control technology of paint mist pollution source, in particular to a control technology of paint mist pollution source with high-speed, turbulent and non-linear transmission characteristics, and specifically to a spray gun nozzle.

### BACKGROUND

Air spray gun is a spraying tool that uses high-speed airflow to atomize the paint into paint mist droplets and spray the paint mist droplets to the surface of the object to be painted. Air spraying does not have many requirements for the paint or the object to be painted. The spraying apparatus is simple and flexible to operate, and the spraying shape and the spraying range may be adjusted freely according to the shape and size of the workpiece. Among the spraying methods, it is the most widely applicable. Particle sizes of the paint mist particles sprayed by the air spray gun are small, and the quality of the paint film is smooth, delicate and beautiful. Therefore, it is the most widely used painting technology and is usually used for topcoat spraying, so as to obtain a higher decorative effect.

The spray gun has a small amount of spray at a time, and it will produce periodic wave-like sprays during the spraying operation, the spraying flow field is a high-speed jet flow and a large speed will be generated at the exit of the nozzle. During the spraying process, a large amount of momentum exchange may occur between the sprays and the surrounding air that is relatively static, resulting in a large speed attenuation. Therefore, during the spraying process, some paint mist particles diffuse into the surrounding air and may not reach the surface of the object to be sprayed due to low speed, which will contaminate the workshop, At the same time, when spraying on the surface of a vertical, angled or radian object, a reverse velocity will be generated, that is, a blanket reverse swirling flow field will appear. A large number of paint mist particles with small particle sizes will be taken away at this time, and the spraying efficiency is below 40%. A large number of toxic paint mist particles and volatile organic solvents diffuse into the painting workshop, causing great harm to the health of painting workers and the environment of the painting workshop.

Therefore, it is very important to improve the spray gun, reduce the escape of the paint mist, increase the spraying efficiency of the paint, and improve the health of painting workers and the environment of the painting workshop. At present, the most widely used methods for controlling paint mist are the mechanical ventilation method to control the propagation path, and the pollutant filtering and purifying treatment method. However, the mechanical ventilation method not only requires a large amount of fresh air to control paint mist, but also requires the laying of quite complicated ventilation ducts; the pollutant filtering and purifying method requires a large amount of purifier equipment and fan energy consumption. In contrast, source control has low operation and maintenance investment and good control effect. Since the high-speed spray gun jet involves the complex momentum and energy exchange process with the surrounding air, and while the entrainment and nonlinear transfer characteristics of paint mist are also accompanied by the entire spraying process, the source control technology requires higher requirements and there are few applications in the painting workshop. Therefore, it is very necessary to provide an efficient source control technology.

### SUMMARY

The present disclosure provides a new type spray gun nozzle, including:

a hood located outside a central nozzle and connected to a spray gun;

an annular spout sleeved on the hood and connected to the hood, wherein the annular spout includes:

a first pipe body;

a second pipe body sleeved with the first pipe body; an annular bottom surface connected with an end of the first pipe body and an end of the second pipe body, wherein the first pipe body, the second pipe body and the annular bottom surface form an annular cavity; and

an annular spout air inlet provided on the annular bottom surface and communicated with the annular cavity; and

an annular spout air inlet pipe connected with the annular spout air inlet.

Optionally, a diameter of the first pipe body is greater than a diameter of the second pipe body.

Optionally, a difference between a diameter of the first pipe body and a diameter of the second pipe body is 1 mm-3 mm.

Optionally, a. number of the annular spout air inlet is at least two.

Optionally, the annular spout air inlets are distributed on the annular bottom surface evenly.

Optionally, an inner wall of the annular spout and an outer wall of the hood are provided with threads, and the annular spout and the hood are connected through the threads.

Optionally, an inner wall of the annular spout air inlet and an outer wall of the annular spout air inlet pipe are provided with threads, and the annular spout air inlet and the annular spout air inlet pipe are connected through the threads.

Optionally, the spray gun nozzle further includes: a sealing pad provided between the annular spout air inlet and the annular spout air inlet pipe.

Optionally, the central nozzle is connected to a paint tank through a pipe.

Optionally, the spray gun nozzle further includes: a central nozzle air inlet connected to an inner cavity of a gun body through a gun handle, wherein air is entered through the central nozzle air inlet to atomize a paint sprayed from the central nozzle.

### BRIEF DESCRIPTION OF THE DRAWINGS

FIG. 1 is a schematic structural diagram of the present disclosure;

FIG. 2 is a schematic structural diagram of an annular spout.

### REFERENCE NUMERALS

central nozzle 1; hood 2; annular spout 3; central nozzle air inlet 4; annular spout air inlet pipe 5; paint tank 6; gun handle 7; gun body 8; first pipe body 3-1; second pipe body 3-2; annular bottom surface 3-3; annular spout air inlet 3-4,

### DETAILED DESCRIPTION OF EMBODIMENTS

The present disclosure will be further described in detail with reference to the accompanying drawings.

Spray guns have problems of paint escape and uneven spraying during the spraying processes. The embodiments of the present disclosure provide a spray gun nozzle. By adding an annular spout on a hood of the spray gun, an annular spray is formed, which serves as a protective airflow so as to prevent the central spray from entraining surrounding air and ensure a uniform radial speed distribution.

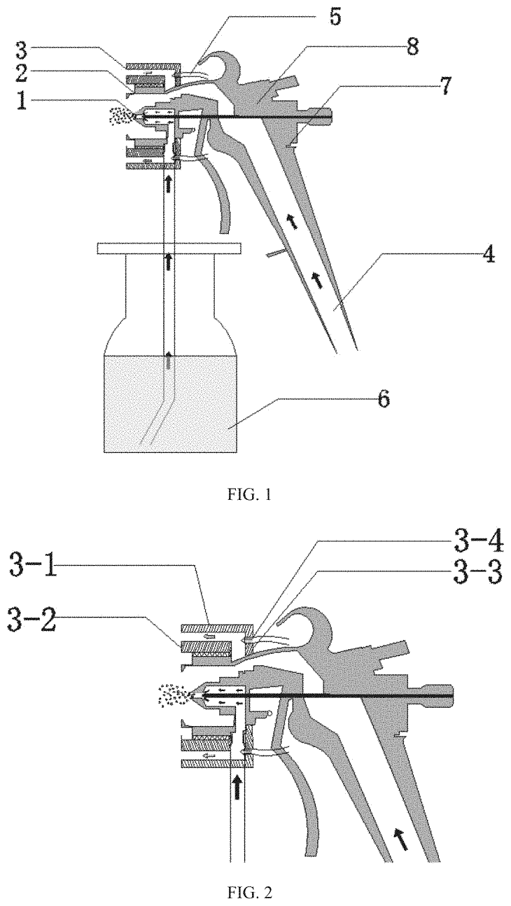

As shown in FIGS. 1-2, a spray gun nozzle provided by the embodiments of the present disclosure includes: a hood 2, an annular spout 3 and an annular spout air inlet pipe 5. The hood 2 is located outside a central nozzle 1 and is connected to a spray gun. The annular spout air inlet pipe 5 is connected to an annular spout air inlet 3-4. The central nozzle 1, the hood 2 and the annular spout 3 are arranged coaxially from the inside to the outside, The spray gun nozzle provided by the embodiments of the present disclosure further includes: a central nozzle air inlet 4 which is connected to an inner cavity of a gun body 8 through a gun handle 7, air is entered through the central nozzle air inlet to atomize a paint sprayed from the central nozzle.

The annular spout 3 includes: a first pipe body 3-1, a second pipe body 3-2, an annular bottom surface 3-3 and an annular spout air inlet 3-4, The first pipe body 3-1 is sleeved with the second pipe body 3-2. The annular bottom surface 3-3 is connected to an end of the first pipe body 3-1 and an end of the second pipe body 3-2, and the first pipe body 3-1, the second pipe body 3-2 and the annular bottom surface 3-3 form an annular cavity. The annular spout air inlet 3-4 is provided on the annular bottom surface 3-3, and the annular spout air inlet 3-4 is communicated with the annular cavity.

In the embodiments of the present disclosure, a diameter of the first pipe body 3-1 is greater than a diameter of the second pipe body 3-2. The first pipe body 3-1 and the second pipe body 3-2 are arranged coaxially, and each of the first pipe body 3-1 and the second pipe body 3-2 is connected to one side of the annular bottom surface 3-3.

In the embodiments of the present disclosure, an inner wall of the second pipe body 3-2 of the annular spout 3 and the hood 2 are provided with threads, and the annular spout 3 and the hood 2 are connected by the threads. In the present disclosure, the annular spout 3 is installed on the hood 2 of an existing air spray gun, and the threads are the key to connecting the annular spout 3 and the hood 2.

Further, an inner wall of the annular spout air inlet 3-4 and an outer wall of an annular spout air inlet pipe 5 are provided with threads, and the annular spout air inlet 3-4 and the annular spout air inlet pipe 5 are connected by the threads. At least two annular spout air inlets 3-4 are distributed on the annular bottom surface 3-3 evenly, so as to ensure a more even gas suction.

In the embodiments of the present disclosure, when the air spray gun is operating, the paint is sprayed out from the central nozzle 1 from a paint tank 6 through a pipe, air is sprayed out from the central nozzle air inlet 4 through the gun body 8, the central nozzle 1 forms a main jet, that is a central jet. A speed of the central jet is, for example, about 60 m/s, an operating temperature of the central jet is, for example, 2-4 atm, and a corresponding flow rate of the central jet is about 96 L/min

The diameter of the first pipe body 3-1 of the annular spout 3 is, for example, about 36 mm, the diameter of the second pipe body 3-2 is, for example, about 35 mm, and the first pipe body 3-1 and the second pipe body 3-2. form an annular air cavity of 1 mm. The annular spout 3 and the central nozzle 1 operate at the same time to form an annular jet with a speed of, for example, 60 m/s, The annular jet is sprayed to an operating surface through a hollow pipe, and may form an annular protective air flow surrounding the central nozzle 1, so as to prevent the central jet from exchanging momentum with ambient air, so that a radial speed of the central jet may be distributed evenly, and problems of escaping and polluting the environment may be reduced, thereby the spraying efficiency of the paint may be improved.

The beneficial effect of the present disclosure is: while the central nozzle is working, an annular air curtain is activated, the annular spout air inlet sucks air from an air intake device through the annular spout air inlet pipe. Air is entered into the annular cavity between the first pipe body and the second pipe body, and then sprayed from the annular cavity to formed the annular air curtain to the operating surface. An annular protective air flow may be formed surrounding the central nozzle, so as to prevent the central jet from exchanging momentum with ambient air, so that a radial speed of the central jet may be distributed evenly, and problems of escaping and polluting the environment may be reduced, thereby the spraying efficiency of the paint may be improved. The spray gun nozzle provided by the embodiments of the present disclosure solves problems of waste of paint due to paint escape, stuff harm and other issues, and may improve the efficiency of the painting operation. The technical processing of the spray gun nozzle provided by the embodiments of the present disclosure is easy to implement, and the production difficulty and cost are reduced.

The above-mentioned embodiments of the present disclosure do not constitute a limitation to the protection scope of the present disclosure. Any modifications and changes made based on the technical concept of the present disclosure should fall within the protection scope of the present disclosure.

1. A spray gun nozzle, comprising:
a hood located outside a central nozzle and connected to a spray gun;
an annular spout sleeved on the hood and connected to the hood, wherein the annular spout comprises:
a first pipe body;
a second pipe body sleeved with the first pipe body;
an annular bottom surface connected with an end of the first pipe body and an end of the second pipe body, wherein the first pipe body, the second pipe body and the annular bottom surface form an annular cavity; and
an annular spout air inlet provided on the annular bottom surface and communicated with the annular cavity; and
an annular spout air inlet pipe connected with the annular spout air inlet.

2. The spray gun nozzle according to claim 1, wherein a diameter of the first pipe body is greater than a diameter of the second pipe body.

3. The spray gun nozzle according to claim 1, wherein a difference between a diameter of the first pipe body and a diameter of the second pipe body is 1 mm-3 mm.

4. The spray gun nozzle according to claim 1, wherein a number of the annular spout air inlet is at least two.

5. The spray gun nozzle according to claim 4, wherein the annular spout air inlets are distributed on the annular bottom surface evenly.

6. The spray gun nozzle according to claim 1, wherein an inner wall of the annular spout and an outer wall of the hood are provided with threads, and the annular spout and the hood are connected through the threads.

7. The spray gun nozzle according to claim 1, wherein an inner wall of the annular spout air inlet and an outer wall of the annular spout air inlet pipe are provided with threads, and the annular spout air inlet and the annular spout air inlet pipe are connected through the threads.

8. The spray gun nozzle according to claim 1, further comprising: a sealing pad provided between the annular spout air inlet and the annular spout air inlet pipe.

9. The spray gun nozzle according to claim 1, wherein the central nozzle is connected to a paint tank through a pipe.

10. The spray gun nozzle according to claim 1, further comprising:
a central nozzle air inlet connected to an inner cavity of a gun body through a gun handle, wherein air is entered through the central nozzle air inlet to atomize a paint sprayed from the central nozzle.
